(19) United States
(12) Patent Application Publication
(10) Pub. No.: US 2003/0057730 A1
(43) Pub. Date: Mar. 27, 2003

(54) Protective barrier

(76) Inventor: Page W. De Laney, Warfordsburg, PA (US)

Correspondence Address: Richard C. Litman, LITMAN LAW OFFICES, LTD., P.O. Box 15035, Arlington, VA, 22215, US

(21) Appl. No.: 10/163,377

(22) Filed: Jun. 7, 2002

Related U.S. Application Data
(60) Provisional application No. 60/296,454, filed on Jun. 8, 2001.

(51) Int. Cl. B60J 9/00

(52) U.S. Cl. 296/136

(57) ABSTRACT

The present invention is a protective barrier having a flexible, puncture-proof sheet which has a plurality of suspension nodes, or impact absorbing domes, which are placed strategically along one side of the sheet to protect the surface of a structure, vehicle, or other object. The domes may be fixedly attached to the sheet or removably attached to the sheet by providing the sheet with a series of parallel slots running along its width, the parallel slots being designed to slidably receive and hold the base of the impact absorbing domes, allowing the domes to be maneuvered along the slots and positioned as desired. Also, a cable mesh may be formed upon or within the sheet in order to reinforce the sheet. The protective barrier may also be provided with a corner brace which is utilized to position the corners of the protective barrier appropriately around a building.

### CROSS-REFERENCE TO RELATED APPLICATION

This application claims the benefit of U.S. Provisional Patent Application Serial No. 60/296,454, filed Jun. 8, 2001.

### FIELD OF THE INVENTION

The present invention relates to protective barriers which can be strung around a building, on a truck, an automobile and the like to protect the surface thereof from flying debris, and more particularly, to a protective barrier having a flexible, puncture-proof sheet which has a plurality of impact absorbing suspension nodes, or domes, which are placed strategically along one side of the sheet to protect the surface of a structure or vehicle.

### DESCRIPTION OF RELATED ART

Protective devices for buildings, automobiles and other objects typically left outdoors are common. The traditional protective cover is a sheet or tarpaulin fashioned from a sturdy, water resistant fabric such as plastic, coated cloth, canvas, or nylon. Grommets are generally found around the periphery of the traditional cover permitting rope or twine to be fed therethrough, facilitating the attachment of the cover to the outdoor object. Several limitations are inherent with the traditional cover, particularly those for covering a portion of an automobile, boat, trailer, or other transport means. Tightening the periphery of the traditional cover adequately around an object to fully protect the object from the elements is very difficult. Typically water and/or particles of dirt may collect under the cover. When left in the sun, the water may become overheated under the cover and ruin the paint job. When driven at high speeds, the cover tends to flap and abrade the surface. Also, the traditional cover does not provide any impact bearing protection for the object other than the inherent protection of the fabric itself.

Improvements have been made on traditional covers for specific uses. U.S. Pat. No. 4,531,560, issued to Balanky on Jul. 30, 1985, discloses a protective cover designed to protect automobiles. The protective cover has a hood cover member, a pair of front body covers, a pair of rear body covers, and means for removably attaching each cover to the corresponding portion of the outside of the vehicle, the attaching means being a plurality of spaced magnets around the perimeter of each cover and a plurality of manually bendable tab clasps around the perimeter of the cutout area of the cover corresponding to the wheel well of the vehicle and at other suitable locations around the perimeter of the cover. The protective cover of Balanky does not contemplate removably attaching the magnets, or adding impact absorbing devices to the inner side of the cover.

U.S. Pat. No. 5,056,817, issued to Fuller on Oct. 15, 1991, describes a flexible automobile bra securable to the exterior surface of an automobile which is constructed of at least one panel designed to absorb mechanical impact, provide mechanical stabilization to inhibit flapping under windy or high-speed conditions, facilitate water drainage, and limit temperature rises of covered portions of the vehicle. The bra comprises a plurality of different layers; however, no removable impact absorbing devices are contemplated.

U.S. Pat. No. 5,292,166, issued to Emery on Mar. 8, 1994, shows a protective shield for the hood of an automobile which covers the front portion of the hood, and protects against insects and road debris damage. The shield has a main body member made of rigid or semi-rigid material, a lip member extending therefrom and a set of spacers attached to the underside of the main body member. The set of spacers is permanently attached to the underside of the main body member and wings. Two spacers are centrally located while the remainder of the spacers are staggered along the peripheral edges of the main body member and the wings.

U.S. Pat. No. 5,429,406, issued to Huang on Jul. 4, 1995, describes a sun shield for motor vehicles which has pockets for inserting magnets therein. The invention of Huang does not provide a protective barrier which protects the motor vehicle from the impact of flying debris. Likewise, the invention of Huang does not have impact absorbing elements.

U.S. Pat. No. 5,632,223, issued to Bray et al. on May 27, 1997, shows a protective covering system for an object exposed to the elements. The protective cover comprises a body, at least one strap connected to the body, a drawstring or elastic cord for holding the bottom edge of the body tightly against the object being covered, and at least one universal clip per strap. No provision is made for impact absorbing devices attached to the invention of Bray et al.

U.S. Pat. No. 5,797,643, issued to Demedash on Aug. 25, 1998, describes a kit for covering the grill of an automobile, which includes a fabric cover with a plurality of female snap fastener elements, a plurality of first male snap fastener elements and a plurality of second male snap fastener elements. The male snap fastener elements may be adhered directly to the automobile, and the fabric cover attached thereto. No device or mechanism is provided for impact absorbency.

United Kingdom Patent Application No. 2,058,696 shows a vehicle cover which consists of a sheet of waterproof flexible material shaped to fit over the bodyshell of a vehicle and to depend beyond the lower regions of the bodyshell. The sheet terminates in a peripheral edge which incorporates a draw-cord, the tensioning of which draws the peripheral edge up and under the vehicle serving to secure the vehicle cover in place. No provision is provided for impact absorption.

None of the above inventions and patents, taken either singly or in combination, is seen to describe the instant invention as claimed.

### SUMMARY OF THE INVENTION

The present invention is a protective barrier having a flexible, puncture-proof sheet which has a plurality of suspension nodes, or impact absorbing domes, which are placed strategically along one side of the sheet to protect the surface of a structure, vehicle, or other object. The domes may be fixedly attached to the sheet or removably attached to the sheet by providing the sheet with a series of parallel slots running along its width, the parallel slots being designed to slidably receive and hold the base of the impact absorbing domes, allowing the domes to be maneuvered along the slots and positioned as desired. Also, a cable mesh may be formed upon or within the sheet in order to reinforce the sheet. The cables making up the cable mesh can be tightened individually like a drawstring, and tied off or otherwise fastened at the free ends, thus molding the protective barrier to evenly cover the object protected. The protective barrier may also be provided with a corner brace which is utilized to position the corners of the protective barrier appropriately around a building.

Accordingly, it is a principal object of the invention to provide a protective barrier that will protect an object from flying debris and physical contact from unprotected sources. The impact absorbing domes space the sheet from the surface of the object, permitting excess water to run off and reducing damage resulting from abrasive contact of the sheet directly against the surface. Likewise, the space provided between the sheet and the surface of the object facilitates air flow therebetween.

It is another object of the invention to provide a protective barrier which can be formed to fit a variety of surfaces. For example, the protective barrier may be manufactured to cover an entire automobile or as a bra to fit over the front of an automobile. The cover may be secured to the automobile by cables which can be tightened and tied off producing a molded fit over the automobile, or a bra may be secured to the automobile by a plurality of hooks. The protective barrier may also be designed to fit over a boat, a truck, a bicycle, work benches, and the like. The molded fit is extremely beneficial because it prevents the protective barrier from uncontrolled movement which might damage the object protected.

It is a further object of the invention to provide a protective cover which can be easily and securely affixed to the sides of a building to protect it from flying debris. Protecting finished parts of buildings and nearby structures is very difficult for construction or demolition companies. The present invention provides an ideal protective covering for that purpose.

Still another object of the invention is to provide a protective covering which has impact absorbing domes disposed on the inner surface thereof that can be positioned as desired so as not to damage the object covered. For example, the impact absorbing domes can be positioned around a window frame thus providing greater protection for the window while reducing the risk of the window being broken by the impact absorbing domes themselves.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a protective barrier according to the present invention formed into a car bra.

FIG. 1A is a perspective view of a protective barrier according to the present invention supplied in bulk form as a roll of material.

FIG. 2 is a section view along the lines 2-2 of FIG. 1.

FIG. 3 is a fragmented plan view of a protective barrier attached to a building according to the present invention.

FIG. 4 is a top view of a protective barrier showing the slots and impact absorbing domes according to the present invention.

FIG. 5 is a top perspective view of a corner brace for a protective barrier according to the present invention.

FIG. 6 is a rear view of a protective barrier sheet showing the slots and cable mesh of the current invention.

Similar reference characters denote corresponding features consistently throughout the attached drawings.

### DETAILED DESCRIPTION OF THE PREFERRED EMBODIMENTS

In its most general form, the present invention is a protective barrier 10 which can be manufactured in various shapes, sizes, and configurations so that the barrier 10 can be used to protect a building A, a truck, an automobile, and other structures in order to protect the surface thereof from flying debris, insects, or contact with objects or substances which may be harmful to the surface or surface finish of the structure. The protective barrier 10 has a flexible, puncture-proof sheet 12 which has a plurality of suspension nodes 20 that can be placed strategically along one side of the sheet 12 to protect the surface of a structure, vehicle or object. The sheet 12 may be fashioned from any suitable material including, but not limited to, vinyl, rubber, plastic, coated cloth, canvas, or nylon. The flexibility of the material from which the sheet 12 is made is advantageous as compared to rigid and semi-rigid materials in several respects, e.g., the barrier 10 is rendered more compact for packaging and transport, the barrier 10 is better able to conform to minor variations and peculiarities of individual structures and surfaces, the sheet 12 may form a flexible air cushion in cooperation with the structure, etc.

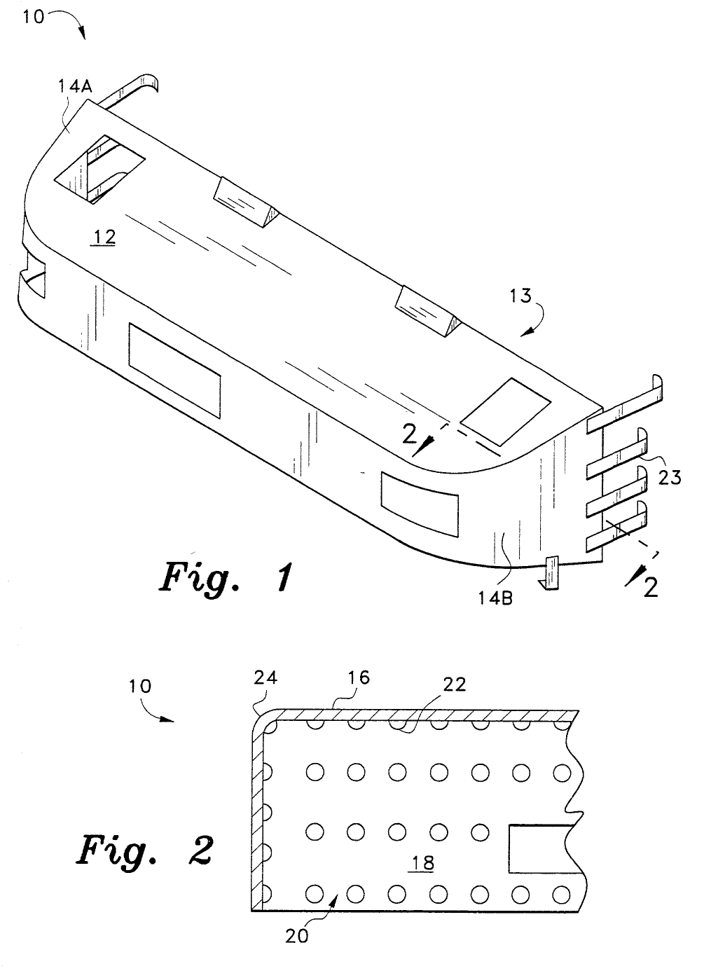

The protective barrier 10 may be supplied in bulk in the form of flat sheets of various dimensions, or in a roll 11 as shown in FIG. 1A. The sheet 12 may be cut into panels of any desired size and shape, which may then be joined by any conventional method appropriate to the material, such as adhesive, sewing, heat sealing, ultrasonic welding, etc., in order to provide a protective barrier 10 adapted to cover or protect an object of any shape or size.

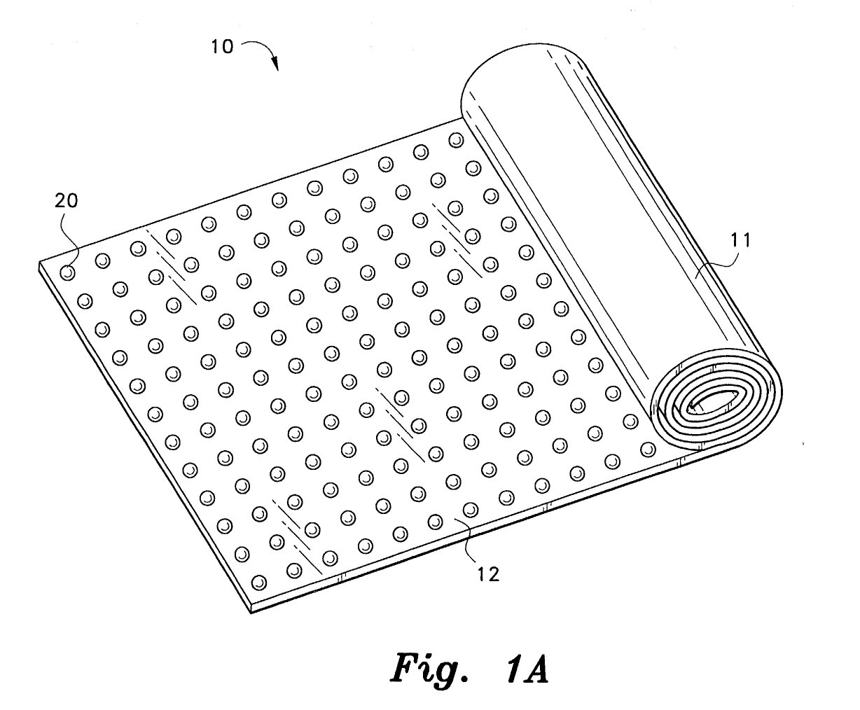

A first embodiment of the protective barrier 10 is shown in FIGS. 1 and 2, in which the sheet 12 has been manufactured in the form of a car bra 13. The car bra 13 may be formed from several panels 14A, 14B of the sheet 12 material which are joined together to cover the front end of an automobile, with cutouts for headlights and air circulation through the grille and radiator, in order to cover and protect the paint surfaces, chrome bumpers, etc. The car bra 13 may be attached to the vehicle by a plurality of hooks 23 or other attachment means. The sheet 12 has a generally smooth front surface 16 facing away from the surface of the automobile, while the rear surface 18 facing towards the automobile has a plurality of suspension nodes 20 disposed thereon to raise the sheet 12 above the surface of the automobile. In this embodiment, the suspension nodes 20 are in the form of dome-shaped or hemispherical protrusions 22 which are fixedly attached to the sheet 12 by being molded or calendared in the sheet 12 during manufacture, by thermal fusion, ultrasonic welding, or by any other conventional means. The domes 22 are preferably made from a resilient material, such as synthetic plastic materials, natural or synthetic rubber, silicone, etc.

In this application, the suspension nodes 20 raise the sheet 12 from the surface of the automobile preferably between about five to ten millimeters. The domes 22 are spaced apart in any desired pattern, but are not spaced closer together than a density of one node per square inch. As shown in FIG. 2, at a location 24 where the barrier 10 has a seam or is disposed above an angle between adjacent surfaces, the barrier 10 is made with suspension nodes 20 along the seam or angle in order to raise the sheet 12 above the corner. It will be understood by those skilled in the art that a car bra 13 is typically custom made for a specific year, make and model of vehicle, so that precise placement of the suspension nodes 20 is quite feasible in this embodiment. The nodes 20 help to act as a shock absorber through their resilience, much like the suspension system of an automobile. The air gap between the sheet 12 and the surface of the vehicle serves as an air cushion, and permits the runoff of surface water to prevent corrosion and the build up of excessive temperature.

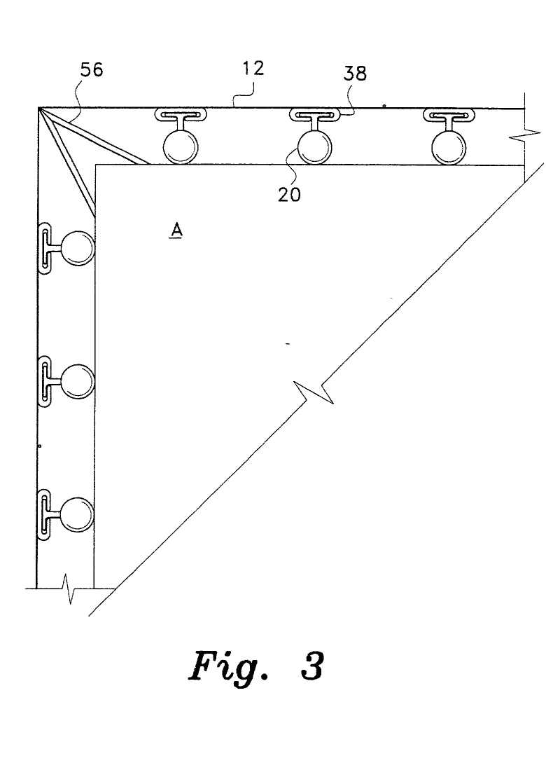

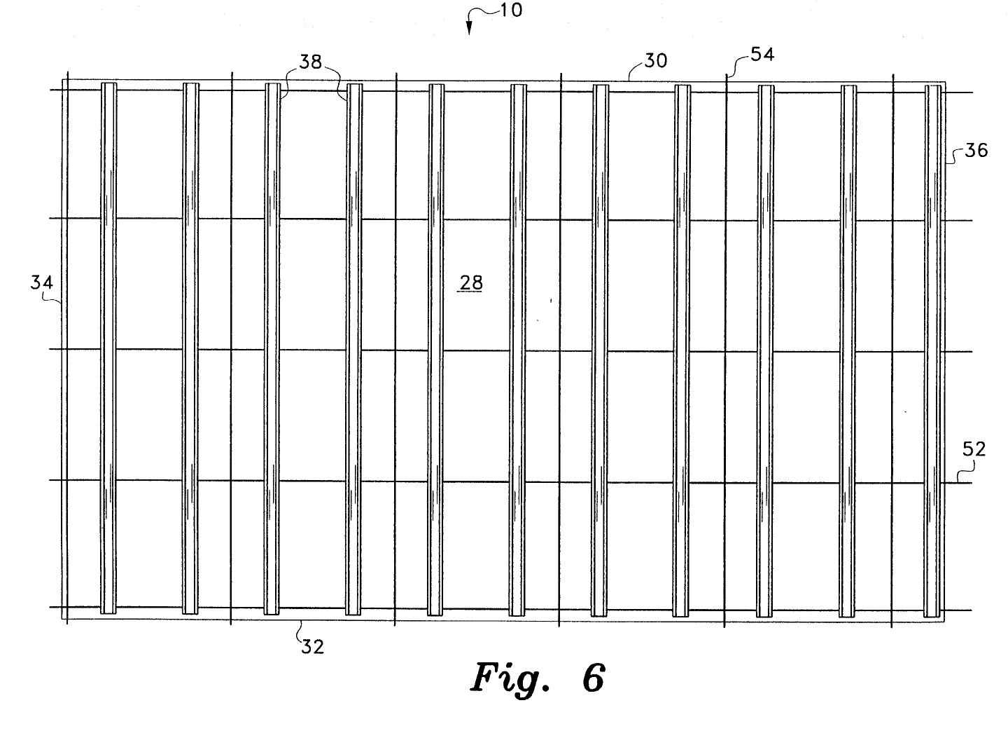

A top view of a second embodiment of a protective barrier 10 surrounding the corner of a building A is shown in FIG. 3. The protective barrier 10 is made up of a sheet 12 having a front surface 26, a rear surface 28, a top 30, a bottom 32, a width measured from the top 30 to the bottom 32, a first side 34, a second side 36 and a length measured from the first side 34 to the second side 36, as shown most clearly from the rear in FIG. 6. The sheet 12 is of various sizes depending on the building, and is preferably of sufficient width to cover one floor and of sufficient length to completely circumnavigate the building.

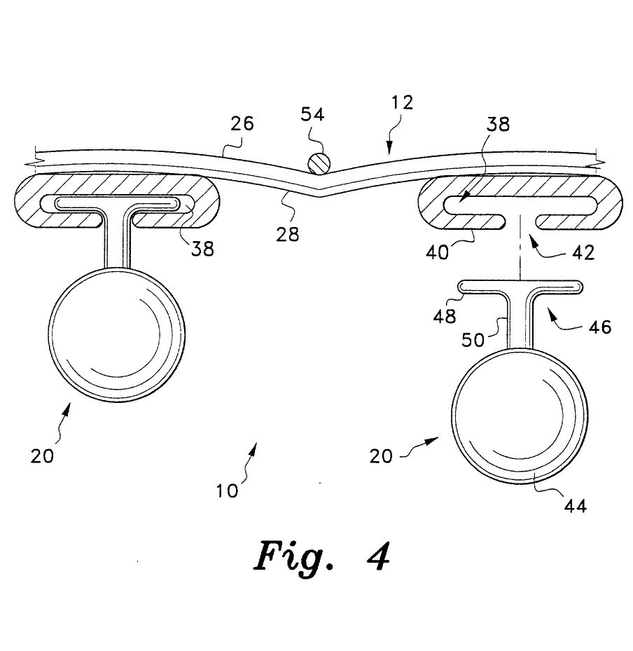

A plurality of slots 38 are disposed on the rear 28 of the sheet 12. The slots 38 run parallel to one another for the width of the sheet from the top 30 to the bottom 32. Each slot 38 has a length equal to or slightly shorter than the length of the width of the sheet 12, and each slot 38 also has two parallel flanges 40 raised above the rear surface 28 of the sheet 12 to define a track 42, as shown most clearly in FIG. 4. The slots 38 are spaced apart according to the application needed. Typically for a building, the slots 38 should be spaced about two inches apart but they may be placed as little as a half inch apart.

The slots 38 are designed to receive a plurality of suspension nodes 20, each node 20 in the form of a sphere 44 mounted on a pedestal 46 consisting of a flat base plate 48 connected to the sphere 44 by a stem 50. The pedestal 46 is shaped so that the plate 48 slides in the slot 38 with the stem 50 sliding in the track 42 as shown in FIG. 4. The slots 38 and the flanges 40 create enough friction between them to hold the suspension nodes 20 in place, and still permit movement of the nodes 20 along the slots 38 upon the application of sufficient pressure. The sphere 44 is preferably made from a resilient, rubbery material, such as a polymer, rubber or other material that will absorb forces but not break or damage the underlying object being protected. The suspension nodes 20 are designed to be placed in strategic places in order to distribute forces appropriately. For example, the nodes 20 may be placed along the periphery of windows to protect the windows from breakage. The nodes 20 may also be placed along structural pillars and other relief structures in order to distribute forces appropriately. Since the slots 38 are placed in a continuous arrangement, different sizes of nodes 20 may be used and spacing may be varied as needed. Also, the nodes 20 may be placed regularly over the entire protective barrier 10 depending on the current need. The nodes 20 used should be of sufficient size to keep the rear 28 of the sheet 12 from contacting the building A, and trapping water or dirt against the building.

Furthermore, a cable mesh may be attached to the protective barrier 10. The cable mesh is made of a first plurality of individual cables 52 attached to the sheet 12 in a horizontal fashion running lengthwise from first 34 to second side 36, and a second plurality of individual cables 54 attached to the sheet 12 in a vertical fashion running the width of the sheet 12 from top 30 to bottom 32, and forming a grid. The cables 52 and 54 are attached by a conventional attachment means permitting movement of the sheet 12 with respect to the cables 52 and 54, thus facilitating the tightening of the protective barrier 10 around an object by tensioning the cables 52 and 54 individually in a manner analogous to drawstrings. Once tensioned the cables 52 and 54 may be tied off to one another or they may be otherwise bound in place in any conventional manner. The cables 52 and 54 may be immovably affixed to the sheet 12 at discrete positions permitting the movement of the sheet 12 relative to the cables 52 and 54, but not permitting the removal of the cables 52 and 54 from the sheet 12. For example, a stitch may be made across the cable in the middle. Any other means of immovably affixing the cables 52 and 54 to the sheet 12 in order to prevent removal from the sheet 12 is within the scope of this invention. The cables 52 and 54 may be made from nylon cord, plastic coated wire, or any other suitable material.

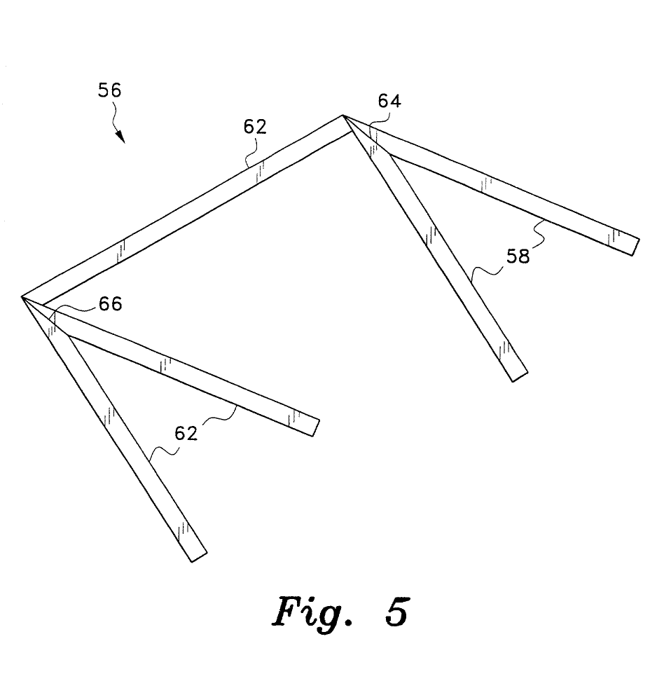

The embodiment of the protective barrier 10 for use on a building A may utilize a corner brace 56, as shown in FIG. 5. The corner brace 56 is designed to hold the sheet 12 away from a corner of a building, and has a first V-frame 58, a second V-frame 60, and a cross beam 62. Each V-frame 58 and 60 has two arms, as shown in FIG. 5, attached to one another forming a V-shape and having an angle of less than 90°. Each V-frame 58 and 60 has a vertex 64 and 66, respectively. The V-frames 58 and 60 are perpendicular to the cross beam 62 and parallel to each other. The corner brace 56 is fashioned from a resilient material.

The corner brace 56 is attached to the corners of the building A, as shown in FIG. 3, with each arm of the V-frames 58 and 60 being placed on the contiguous walls with the cross beam 62 running parallel to the vertex of the contiguous walls. The sheet 12 is draped around the periphery of the building A and around the corner brace 56 such that the sheet 12 is held in place with respect to the building A, and the corner brace 56 likewise is held in place by the tension placed on the cables 52 and 54. Alternatively, the corner brace 56 may be attached to the building A in some other manner.

Additional embodiments of the present invention are also contemplated. Besides a rectangular shaped sheet, as discussed hereinbefore, the protective barrier 10 may be shaped to fit over the top of an automobile. Also, the protective barrier 10 may be formed to fit over a boat. The protective barrier 10 also may be of various sizes and shapes as well. Additionally, the cable mesh 52 and 54 and the slots 38 may be arranged differently. For example, a circular sheet may be used where the slots 38 fan out radially from a central point, and the cables 52 and 54 also fan out from a central point with additional cables arranged in a concentric manner around the middle of the circular sheet forming successively larger circles up to the periphery of the sheet.

It is to be understood that the present invention is not limited to the sole embodiments described above, but encompasses any and all embodiments within the scope of the following claims.

I claim:

1. A protective barrier for protecting the surface of a structure, comprising:
a) a sheet defining at least one panel, the sheet being made from a flexible, puncture resistant material and having a front surface and a rear surface;
b) a plurality of suspension nodes disposed on the rear surface of said sheet; and
c) attachment means for attaching the sheet to a structure to be protected with the rear surface of the sheet facing the structure, the suspension nodes maintaining the sheet in spaced apart relation from the structure.

2. The protective barrier according to claim 1, wherein said sheet comprises a plurality of panels joined together to form a car bra.

3. The protective barrier according to claim 2, wherein the rear surface of said car bra has a plurality of suspension nodes aligned along seams and locations wherein said car bra is disposed along an angle of the structure.

4. The protective barrier as in claim 2, wherein said suspensions nodes are distributed uniformly along the rear surface of said car bra.

5. The protective barrier as in claim 2, wherein several holes are defined in said car bra, said holes being adapted to allow light to escape from an attached car's headlights and to allow air to enter an attached car's headlights.

6. The protective barrier according to claim 1, wherein said sheet is substantially rectangular and adapted for wrapping around a portion of a building.

7. The protective barrier according to claim 6, further comprising at least one corner brace attachable to a corner of the building, the corner brace being disposed between said sheet and the building in order to maintain said sheet in spaced apart relation from the corner of the building.

8. The protective barrier according to claim 6, wherein said corner braces comprises:
a) a first pair of arms defining a first V-shaped frame having a first vertex;
b) a second pair of arms defining a second V-shaped frame having a second vertex;
c) a cross beam connecting said first vertex to said second vertex; and
d) wherein said corner brace is made from a resilient material.

9. The protective barrier according to claim 1, wherein each of said suspension nodes comprises a resilient, hemispherical dome fixedly attached to the rear surface of said sheet.

10. The protective barrier according to claim 1, wherein each of said suspension nodes is slidably attached to the rear surface of said sheet.

11. The protective barrier according to claim 1, wherein:
a) each of said suspension nodes comprises a resilient sphere mounted on a pedestal having a flat base plate and a stem connecting the base plate to the sphere; and
b) the rear surface of said sheets further comprises a plurality of slots extending across the width of the rear surface, the pedestal of each of said suspension nodes being slidable in said slots.

12. The protective barrier according to claim 1, further comprising:
a) a plurality of vertically disposed cables attached to said sheet;
b) a plurality of horizontally disposed cables attached to said sheet, said vertically disposed cables and said horizontally disposed cables forming a reinforcing grid, said cables being for tightening said sheet about the structure to be protected.

13. The protective barrier as in claim 12, further comprising:
a plurality of cord locks, one disposed upon the each end of each said cable.

14. The protective barrier according to claim 1, wherein said sheet is circular, and the protective barrier further comprises:
a) a plurality of radially disposed cables attached to said circular sheet, said cables originating from a position at or near the center of said circular sheet;
b) a plurality of concentrically disposed cables attached to said sheet, with the innermost cable being positioned around or substantially around the center of said circular sheet,
said cables being for tightening said sheet about a structure to be protected.

15. The protective barrier as in claim 1, wherein said sheet comprises a plurality of panels joined together to form a boat cover.

16. The protective barrier as in claim 1, wherein said sheet comprises a plurality of panels joined together to form a vehicle cover.
